(19) United States
(12) Patent Application Publication
(10) Pub. No.: US 2020/0086340 A1
(43) Pub. Date: Mar. 19, 2020

(54) APPLICATION NOZZLE

(71) Applicant: Atlas Copco IAS GmbH, Bretten (DE)

(72) Inventors: Sten MITTAG, Karlsruhe (DE); Heiko BITZEL, Karlsruhe (DE)

(73) Assignee: Atlas Copco IAS GmbH, Bretten (DE)

(21) Appl. No.: 16/616,585

(22) PCT Filed: May 14, 2018
(86) PCT No.: PCT/EP2018/062320

§ 371 Date: Nov. 25, 2019

(30) Foreign Application Priority Data
Jun. 12, 2017 (DE) 10 2017 112 892.1

(51) Int. Cl. B05C 5/02; B05B 1/20; B33Y 80/00

(52) U.S. Cl. CPC B05C 5/0258; B33Y 80/00; B05B 1/20

(57) ABSTRACT

An application nozzle for applying viscous material to a workpiece includes a nozzle body which has a material inlet opening and material outlet openings which are arranged in at least one row in a material outlet face. An inlet channel extends in the nozzle body from the material inlet opening to at least one branch point. At each branch point, two distributor channels extend in the nozzle body in opposite directions from the inlet channel, wherein the distributor channels are each arranged over their entire length at a distance from the material outlet face, and at least one outlet channel extends in the nozzle body from each of the distributor channels in each case to one of the material outlet openings.

The invention relates to an application nozzle for application of viscous material to a workpiece, in accordance with the preamble of claim 1.

Such an application nozzle is known, for example, from U.S. Pat. Nos. 6,695,923 B1 and 7,332,035 B1. It has a nozzle body having a material inlet opening, with which a metering valve is connected, by way of which valve the viscous material can be introduced into a distributor chamber forming a cavity in the nozzle body, in metered manner. Downward the distributor chamber is delimited by an application plate, in which material outlet openings arranged in one or more rows are situated. Such application nozzles allow material application over an area. In practice, however, it has been shown that the thread-like material strands that exit from the material outlet openings do not extend parallel to one another from the material outlet openings to the workpiece, but rather that in particular, the material strands that exit at the outer ends are inclined in the direction toward the center. As a result, the desired uniformity of material application is not always guaranteed.

It is therefore the task of the invention to further develop an application nozzle of the type mentioned initially, in such a manner that more uniform material application can take place.

This task is accomplished, according to the invention, by means of an application nozzle having the characteristics of claim 1. Advantageous further developments of the invention are the object of the dependent claims.

In contrast to the state of the art, in the case of the present invention no distributor chamber is provided, from which the material outlet openings extend through an application plate, but rather at least two distributor channels are provided in the nozzle body, which are arranged at a distance from the material outlet surface over their entire length. From the distributor channels, an outlet channel extends to each material outlet opening, through which the material to be applied is passed. In experiments, it was found that such a geometry contributes to reducing the deviation of the material strands that exit from the material outlet openings from a precisely parallel orientation of the material strands relative to one another. In this regard, it is possible that the inlet channel extends precisely to a branch point. However, it is also possible that the inlet channel has a pre-branch into at least two partial inlet channels, which each extend to a branch point.

Multiple advantageous further developments serve to further increase the parallelity of the exiting material strands relative to one another. In particular, it is preferred that the outlet channels run essentially parallel to one another. It is furthermore advantageous if the inlet channel, if applicable including partial inlet channels, the distributor channels, and the outlet channels form a cavity in the nozzle body that is symmetrical with reference to a center plane. The material application is further improved if the distributor channels are arranged, at every point, at a distance from the material outlet surface that is at least 1.5 times as great and preferably at least 2 times as great as the diameter of the material outlet openings. In this regard, it is possible that all the material outlet openings have the same size. However, it is also possible that the material outlet openings have different sizes, wherein the preferred ratio of the distance of the distributor channels from the material outlet surface to the diameter of the material outlet openings relates to the largest material outlet opening, in each instance.

According to an advantageous further development, it is provided that the outlet channels have an initial region that branches off from one of the distributor channels and an end region that extends to the related material outlet opening, in each instance, wherein the diameter of the end region is smaller than the diameter of the initial region. In this regard, it is preferred that the diameter of each of the outlet channels decreases in steps at the transition from the initial region to the end region. Production of the application nozzle is simplified by means of these measures. This nozzle can be produced in particularly simple manner in that a blank of the nozzle body is produced by means of a 3D printing method. In order to achieve the smoothest surfaces possible of the nozzle body in the region of the material outlet openings, which surfaces are advantageous for the flow behavior of the viscous material, it is practical if the end regions of the outlet channels are introduced into the blank by means of drilling. Furthermore, the material outlet surface is preferably formed by means of grinding a surface of the blank, wherein the grinding preferably takes place after drilling of the end regions of the outlet channels. Since drilling of the end regions can only take place with great effort to achieve such precision that the inner walls that delimit the initial regions align precisely with the inner walls that delimit the end regions, the end regions are configured with a smaller diameter than the initial regions, so that no offset of the end regions relative to the initial regions is formed even if their center axes do not precisely coincide.

In order to improve the flow behavior of the viscous material in the region of the material outlet openings, it is preferred that the end regions run essentially perpendicular to the material outlet surface. This can be achieved with great precision by means of the preferred production method with 3D printing of the blank and subsequent drilling of the end regions, and grinding with subsequent hardening of a surface of the blank, if applicable, bringing about the formation of the material outlet surface, so that the inner surfaces of the end regions enclose a 90° angle, as precisely as possible, with the material outlet surface.

Experiments have shown that the flow behavior of the viscous material can be improved if multiple outlet channels extend from each distributor channel to the material outlet surface, and all of the outlet channels that branch off from one of the distributor channels have a different length. In this regard, it is preferred that the length of the outlet channels is all the shorter, the farther away from the branching point the outlet channel in question branches off from the related distributor channel.

A further improvement in the flow behavior of the viscous material can be achieved if each of the distributor channels has at least two consecutive sections that are curved in different directions. It is furthermore advantageous, in this connection, if each of the distributor channels first narrows, proceeding from the branching point, and then widens again. In this regard, it is furthermore preferred that each of the distributor channels narrows again toward its end.

It is practical if the nozzle body is produced in one piece and is preferably produced from metal, in particular stainless steel or aluminum.

It is possible that the nozzle body has only one cavity formed by the inlet channel, the distributor channels, and the outlet channels. However, it is also possible that the nozzle body has two or more cavities having the identical geometry, each formed by an inlet channel, two distributor channels, and multiple outlet channels. As a result, the width of the material strip to be applied to the workpiece can be further increased in size, if the row of the further material outlet openings follows the row of the outlet openings.

To achieve a uniform material application, it is preferred that the material outlet openings and, if applicable, the further material outlet openings of each row are arranged at the same distances from one another. Furthermore, it is preferred that the last of the material outlet openings or of the further material outlet openings of each row, in each instance, are arranged at a distance from an edge of the nozzle body that corresponds to half the distance between the material outlet openings or between the further material outlet openings. Then it is possible to join multiple such application nozzles together, so as to lengthen the row of the material outlet openings, while maintaining the reciprocal distance.

In the following, the invention will be explained in greater detail using an exemplary embodiment shown schematically in the drawing. This shows:

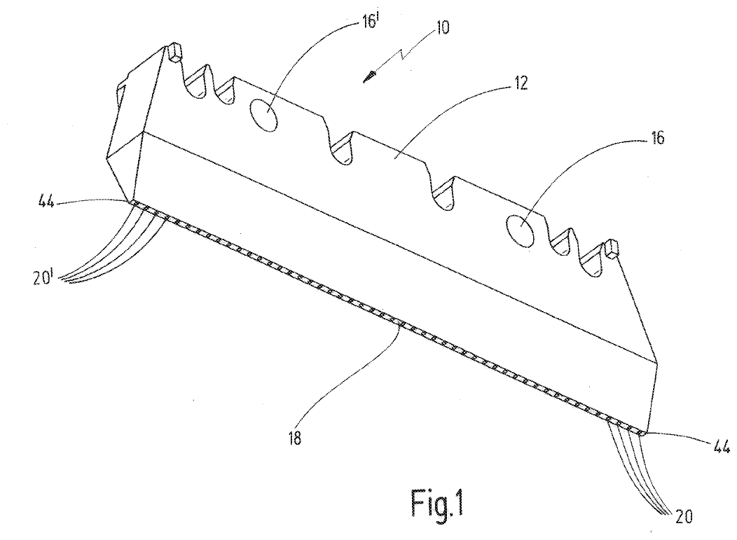

FIG. 1 an application nozzle in a perspective view;

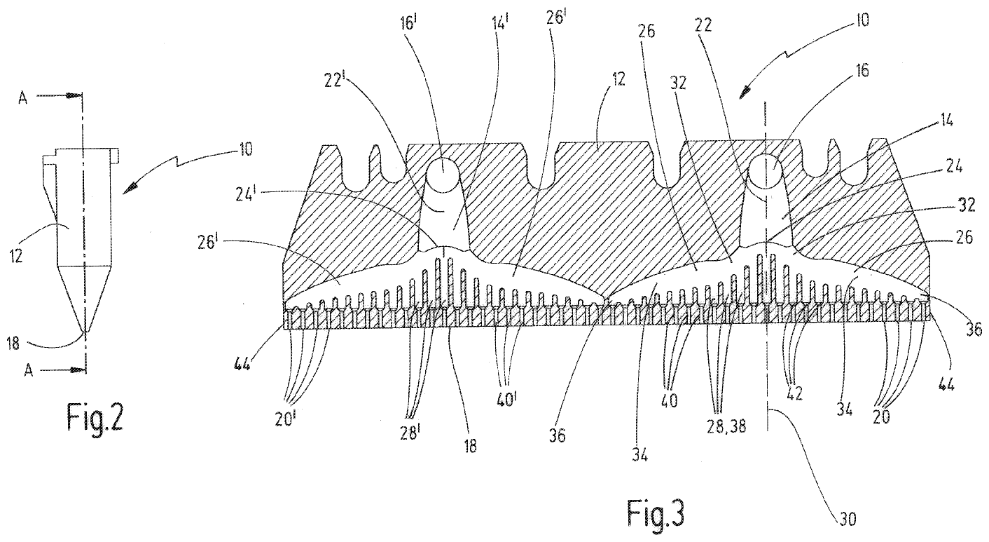

FIG. 2 the application nozzle according to FIG. 1 in a top view onto its end face, and

FIG. 3 a representation of the application nozzle according to FIGS. 1, 2 in section along the line A-A.

The application nozzle 10 shown in the drawing serves for application of a viscous material to a workpiece. It has a nozzle body 12 that is produced in one piece from stainless steel or aluminum, and in which a cavity 14 is arranged. The viscous material can be introduced into the cavity 14 by way of a material inlet opening 16, with which a metering valve can be connected. Downward, the nozzle body 12 is delimited by a material outlet surface 18, in which multiple material outlet openings 20 are arranged in a row. An inlet channel 22 extends from the material inlet opening 16 all the way to a branching point 24, from which two distributor channels 26 extend in opposite directions. A plurality of outlet channels 28 extend from each of the distributor channels 26 to the material outlet surface 18, wherein each of the outlet channels 28 ends at one of the material outlet openings 20.

The cavity 14 formed by the inlet channel 22, the distributor channels 26, and the outlet channels 28 is symmetrical with reference to a center plane 30 that stands perpendicular to the drawing plane of FIG. 3. Each of the distributor channels 26 has an essentially S-shaped curvature having a first section 32, which is curved in a first direction, and a second section 34, which is curved in a second direction opposite to the first direction. The cross-section of the distributor channels 26 narrows at first, proceeding from the branching point 24, before it widens again and narrows again toward an end 36 of the distributor channel 26. All of the outlet channels 28 that branch off from one of the distributor channels 26 have a different length, wherein this length is measured between the respective distributor channel 26 and the material outlet surface 18. In this regard, the length of the outlet channels 28 is all the shorter, the farther away from the branching point 24 the respective outlet channel 28 is located. In this regard, the outlet channel 28 that begins directly at the branching point 24 branches off both from one and from the other channel 26. The length of the outlet channels 28 corresponds to at least 1.5 times, in the exemplary embodiment shown actually 3 times the diameter of the material outlet openings 20, which all have an identical size. Each of the outlet channels 28 furthermore has an initial region 38 that branches off directly from the respective distributor channel 26, and an end region 40 that extends to the related material outlet opening 20, wherein the end regions 40 have a lesser diameter than the initial regions 38. The transition between the initial region 38 and the end region 40 of each of the outlet channels 28 takes place at a step 42.

The application nozzle 10 has a further cavity 14′ in its nozzle body 12, which cavity is configured to be identical with the cavity 14. The further cavity 14′ is formed by a further inlet channel 22′, two further distributor channels 26′, and further outlet channels 28′, and can be filled with viscous material by way of a further material inlet opening 16′. The further outlet channels 28′ end at further material outlet openings 20′, which are arranged in a row in the material outlet surface 18, which row represents a continuation of the row formed by the material outlet openings 20. A metering valve can be connected with the further material outlet openings 16′, as well. The material outlet openings 20 and the further material outlet openings 20′ are arranged at equal reciprocal distances. The outermost of the material outlet openings 20 or of the further material outlet openings 20′, in each instance, are arranged at a distance from an edge 44 of the nozzle body 12 that corresponds to half the reciprocal distance.

In the production of the application nozzle 10, first a blank of the nozzle body 12 is produced by means of a 3D printing method. No material outlet openings 20, 20′ are present yet in this blank, since the end regions 40, 40′ of the outlet channels 28, 28′ have not yet been formed. These are introduced in a second method step, by drilling into the blank. Finally, the material outlet surface 18 is formed by means of grinding the surface of the blank that is directed downward.

In summary, the following should be stated: The invention relates to an application nozzle 10 for application of viscous material to a workpiece, having a nozzle body 12 that has a material inlet opening 16 and multiple material outlet openings 20, which are arranged in at least one row in a material outlet surface 18. According to the invention, it is provided that an inlet channel 22 extends in the nozzle body 12 from the material inlet opening 16 all the way to at least one branching point 24, that two distributor channels 26 extend in the nozzle body 12 in opposite directions from the inlet channel 22 at each branching point 24, wherein the distributor channels 26 are arranged at a distance from the material outlet surface 18 over their entire length, in each instance, and that at least one outlet channel 28 extends in the nozzle body 12 from each distributor channel 26 all the way to one of the material outlet openings 20, in each instance.

1. An application nozzle for application of viscous material to a workpiece, having a nozzle body (12) that has a material inlet opening (16) and multiple material outlet openings (20), which are arranged in at least one row in a material outlet surface (18), wherein an inlet channel (22) extends in the nozzle body (12) from the material inlet opening (16) all the way to at least one branching point (24), wherein two distributor channels (26) extend in the nozzle body (12) in opposite directions from the inlet channel (22) at each branching point (24), wherein the distributor channels (26) are arranged at a distance from the material outlet surface (18) over their entire length, in each instance, and wherein at least one outlet channel (28) extends in the nozzle body (12) from each distributor channel (26) all the way to one of the material outlet openings (20), in each instance.

2. The application nozzle according to claim 1, wherein the outlet channels (28) run essentially parallel to one another.

3. The application nozzle according to claim 1, wherein the inlet channel (22), the distributor channels (26), and the outlet channels (28) form a cavity (14) in the nozzle body (12), which cavity is symmetrical with reference to a center plane (30).

4. The application nozzle according to claim 1, wherein the distributor channels (26) are arranged, at every point, at a distance from the material outlet surface (18) that is at least 1.5 times as great and preferably at least 2 times as great as the diameter of the material outlet openings (20).

5. The application nozzle according to claim 1, wherein the outlet channels (28) have an initial region (38) that branches off from one of the distributor channels (26) and an end region (40) that extends to the related material outlet opening (20), in each instance, wherein the diameter of the end region (40) is smaller than the diameter of the initial region (38).

6. The application nozzle according to claim 5, wherein the diameter of each of the outlet channels (28) decreases in steps at the transition from the initial region (38) to the end region (40).

7. The application nozzle according to claim 5, wherein the end regions (40) run essentially perpendicular to the material outlet surface (18).

8. The application nozzle according to claim 1, wherein multiple outlet channels (28) extend from each distributor channel (26) to the material outlet surface (18), and all of the outlet channels (28) that branch off from one of the distributor channels (26) have a different length.

9. The application nozzle according to claim 8, wherein the length of the outlet channels (28) is all the shorter, the farther away from the branching point (24) the outlet channel (28) in question branches off from the related distributor channel (26).

10. The application nozzle according to claim 1, wherein each of the distributor channels (26) has at least two consecutive sections (32, 34) that are curved in different directions.

11. The application nozzle according to claim 1, wherein each of the distributor channels (26) first narrows, proceeding from the branching point (24), and then widens again.

12. The application nozzle according to claim 11, wherein each of the distributor channels (26) narrows again toward its end (36).

13. The application nozzle according to claim 1, wherein the nozzle body (12) is produced in one piece and is preferably produced from metal, in particular stainless steel or aluminum.

14. The application nozzle according to claim 1, wherein the nozzle body (12) has at least one further material inlet opening (16′) and multiple further material outlet openings (20′) in the material outlet surface (18), wherein a further inlet channel (22′) extends in the nozzle body (12) from the further material inlet opening (16′), all the way to at least one further branching point (24′), wherein two further distributor channels (26′) extend, in the nozzle body (12), in opposite directions from the further inlet channel (22′) at each further branching point (24′), wherein the further distribution channels (26′) are arranged at a distance from the material outlet surface (18) over their entire length, in each instance, and wherein at least one further outlet channel (28′) extends in the nozzle body (12) all the way to one of the further material outlet openings (20′), in each instance, from each of the further distributor channels (26′), wherein the inlet channel (22), the distributor channels (26), and the outlet channels (28), on the one hand, and the further inlet channel (22′), the further distributor channels (26′), and the further outlet channels (28′), on the other hand, form two cavities (14, 14′) in the nozzle body (12), which cavities have an identical geometry.

15. The application nozzle according to claim 1, wherein the material outlet openings (20) and, if applicable, the further material outlet openings (20′) of each row are arranged at equal distances from one another.

16. The application nozzle according to claim 15, wherein the last of the material outlet openings (20) or of the further material outlet openings (20′) of each row, in each instance, are arranged at a distance from an edge (44) of the nozzle body (12) that corresponds to half the distance between the material outlet openings (20) or between the further material outlet openings (20′).

17. A method for the production of the application nozzle according to claim 1, wherein a blank of the nozzle body (12) is produced by means of a 3D printing process.

18. The method according to claim 17, wherein the end regions (40) of the outlet channels (28) are introduced into the blank by means of drilling.

19. The method according to claim 17, wherein the material outlet surface (18) is formed by means of grinding and preferably subsequent hardening of a surface of the blank.
